(19) United States
(12) Patent Application Publication
(10) Pub. No.: US 2026/0118056 A1
(43) Pub. Date: Apr. 30, 2026

(54) ELECTRO-OSMOSIS-ASSISTED DRYING FOR AEROGELS

(71) Applicant: Trustees of Tufts College, Medford, MA (US)

(72) Inventors: Hy Dinh, Medford, MA (US); Georgios Karamanis, Medford, MA (US)

(21) Appl. No.: 19/111,864

(22) PCT Filed: Sep. 15, 2023
(86) PCT No.: PCT/US2023/074394

§ 371 Date: Mar. 14, 2025

Related U.S. Application Data
(60) Provisional application No. 63/375,709, filed on Sep. 15, 2022.

(51) Int. Cl. F26B 3/34; F26B 5/00

(52) U.S. Cl. CPC F26B 3/34; F26B 5/005

(57) ABSTRACT

The present disclosure provides systems and methods for accelerating the aging and/or drying process of making aerogels via the use of an external electric field to induce an electro-osmotic flow inside the pores of an alcogel, rather the relying solely on diffusion-limited mass exchange. To overcome the time and cost of conventional aerogel manufacturing that requires long, involved, and costly processing, the present disclosure provides systems and methods for generating a potential difference across the alcogel to induce advection inside the pores.

### CROSS-REFERENCES TO RELATED APPLICATIONS

The present application is based on, claims priority to, and incorporates herein by reference in its entirety for all purposes, U.S. Provisional Application Ser. No. 63/375,709 filed Sep. 15, 2022.

### STATEMENT REGARDING FEDERALLY SPONSORED RESEARCH

Not Applicable.

### BACKGROUND

Aerogel is class of mesoporous materials, i.e., materials with a nanostructured skeleton network and containing pores with diameter ranging from, about 2 to 100 nm. Among them, silica aerogel is commonly known for its unique characteristics such as low thermal conductivity (˜0.015 W/m·K) (Yoldas et al., Chemical Engineering of Aerogel Morphology Formed under Nonsupercritical Conditions, 2000), low density (˜10 kg/m³) (Aegerter et al., Aerogel Handbook, 2011), and high specific surface area (−250 m2/g) (Aegerter et al.). As such, silica aerogels are often used in applications involving super-insulation, plastic replacements, drug delivery, etc.

Silica aerogel is synthesized by a sol-gel process where a silicon alkoxide precursor, typically tetramethyl orthosilicate (TMOS) or tetraethyl orthosilicate (TEOS), undergoes hydrolysis to form solid particles suspended in a liquid (a colloidal solution-sol). Then a base or acid catalyst is added to the solution to accelerate the polymerization, crosslinking the particles and forming an interconnected 3D porous nanoskeleton filled with a solvent (gel). At this stage, this wet-gel is referred to by its pore fluid: alcogel for alcohol and hydrogel for water. Then, hydrolysis and condensation continue to occur as the wet-gel subsequently undergoes ageing (often including solvent exchange) to strengthen its structure and remove contaminants formed during gelation. Typically, the solvent exchange process involves extended periods of rinsing the wet-gel to replace the contaminated solvent with pristine solvent. The final step to obtain an aerogel requires removing the pore fluid while preserving the delicate nanostructure.

Diffusion-limited mass transfer governs the solvent exchange part of the ageing process, a day(s)-long step where the alcohol is purified to remove salts and water. It also largely governs the commonly used supercritical carbon dioxide (SCCO₂) drying process, whereby the pure alcohol is replaced by CO₂, and, subsequently, air to form an aerogel. The SCCO₂ drying process prevents capillary forces from collapsing the fragile nanoskeleton of the gel by circumventing the liquid vapor boundary relative to ambient drying techniques. The use of expensive surfactants and time-consuming chemistry in ambient drying to reduce the surface tension formed at the menisci such that alcohol can evaporate without causing capillary forces to compromise the delicate nanostructure of an aerogel or freeze-drying techniques does little to solve the efficiency problem. Likewise, freeze-drying is an extremely slow process because the rate of sublimation is extremely small due to the exceptionally small vapor pressure of the solvent at temperatures required to keep it frozen, despite largely avoiding capillary forces on due to a solid-vapor interface rather than a liquid-vapor interface as the alcohol in the alcogel is gradually replaced by air. The primary limitations on SCCO₂ drying are the time-consuming solvent exchange between CO₂ and the pore fluid and the copious amounts of CO₂ consumption, which must be recycled, an energy intensive and expensive process.

Thus, there is a need to enhance drying speeds and associated material cost of aerogels while maintaining the pore structure within the aerogels.

### SUMMARY

The present disclosure provides systems and methods that overcome the aforementioned drawbacks by providing an electro-osmotic component to aging and/or drying alcogels for the production of aerogels.

Due to the nanopores inside the gel, the supercritical fluid drying process, such as SCCO₂ drying, is diffusion limited with minimal advection via suction and spillage effects as investigated by, e.g., Karamanis et al. (Effects of suction and spillage on supercritical carbon dioxide-based drying of aerogels, 2018). This advective component is caused by the non-monotonic behavior of CO₂-ethanol mixture density across the full concentration range. To accelerate the drying process, one can enhance the existing transport phenomena or introduce an additional advective component. The latter can be achieved through electro-osmosis-assisted drying. Electro-osmosis assisted drying substantially accelerates the drying process by generating an advective component to the otherwise diffusion-dominated transport.

In one aspect of the present disclosure, a system for aging and/or drying a gel having a polar fluid within pores of the gel is described. The system comprises a gel having a polar fluid within pores of the gel, wherein an electrical double layer is formed on at least a portion of inner surfaces of the pores of the gel. The system further comprises an anode and a cathode, wherein the cathode is spaced apart from the anode to define a volume for receiving the gel. The system further comprises a power supply in electrical communication with the anode and the cathode for generating an electro-osmotic flow of the polar fluid toward one of the anode or the cathode. The system further comprises a source containing an additional fluid, wherein the source is configured to supply the additional fluid to the pores of the gel.

In an aspect of the system, the volume may include a series of plates arranged from a proximal end to a distal end of the volume.

In another aspect of the system, the series of plates may include a plate including a first opening adjacent to a plate including a hole with the anode therein adjacent to a plate including a first vertical vent and first horizontal port adjacent to a gel mold adjacent to a plate including a second vertical vent and a second horizontal port adjacent to a plate including a hole with the cathode therein adjacent to a plate including a second opening.

In another aspect of the system, the first opening may be configured to allow an electrical connection from the power supply to the anode, and the second opening is configured to allow an electrical connection from the power supply to the cathode.

In another aspect of the system, the electrical connection to the anode and the cathode may be via enamel coated wires.

In another aspect of the system, the first horizontal port and the second horizontal port may be configured to receive a first tube and second tube, respectively.

In another aspect of the system, the first tube may be coupled to the source containing the additional fluid to introduce the additional fluid into the volume, and the second tube is coupled to a collection container to receive the polar fluid out of the volume.

In another aspect of the system, the gel mold may comprise a plurality of stacked plates.

In another aspect of the system, each of the plurality of stacked plates may include an opening.

In another aspect of the system, each adjacent plate in the plurality of stacked plates may include alternating openings of a first size and a second size, wherein the first size and the second size are different.

In another aspect of the system, a gasket may be positioned between each adjacent plate and between the gel model and each adjacent plate, to seal the volume.

In another aspect of the system, the gel may be positioned within the gel mold.

In another aspect of the system, an amplifier may be in electrical communication with the anode, the cathode, and the power supply.

In another aspect of the system, the additional fluid may be a different polar fluid than the polar fluid.

In another aspect of the system, the additional fluid may be an alcohol having the formula RₓCH_{y}OH, wherein x=3−y, and x and y are integers.

In another aspect of the system, the additional polar fluid may be selected from the group consisting of ethanol, methanol, and mixtures thereof.

In another aspect of the system, the additional fluid may include carbon dioxide (CO₂), ethanol, methanol, acetone, 2-propanol, xenon, hexane, or toluene.

In another aspect of the system, the gel may be a silica-based or metal oxide-based gel.

In another aspect of the system, the gel may be an alcogel.

In another aspect of the system, the pores may have a diameter in a range of 2-100 nm.

In another aspect of the present disclosure, a method of aging and/or drying a gel having a polar fluid within pores of the gel is described. The method comprises the steps of (a) forming a gel having a polar fluid in pores of the gel, wherein an electrical double layer is formed on at least a portion of inner surfaces of the pores of the gel, (b) inserting the gel into a volume between an anode and a cathode, (c) introducing an additional fluid into the pores of the gel, and (d) generating a potential difference across the gel to replace at least a portion of the polar fluid with the additional fluid.

In an aspect of the method, step (d) may create an aged gel.

In another aspect of the method, the gel may be an alcogel.

In another aspect of the method, introducing the additional fluid into the pores of the gel may include using two syringes each connected to a first port and a second port of the volume until the additional fluid completely fills a first vent and a second vent of the volume.

In another aspect of the method, the first vent may be sealed with a first plug and the second vent is sealed with a second plug.

In another aspect of the method, the two syringes may be replaced with a first tube and a second tube.

In another aspect of the method, the first tube may be coupled to the source containing the additional fluid to introduce the additional fluid into the volume, and the second tube may be coupled to a collection container to receive the polar fluid out of the volume.

In another aspect of the method, the additional fluid may be a different polar fluid than the polar fluid.

In another aspect of the method, the additional fluid may be an alcohol having the formula RₓCH_{y}OH, wherein x=3−y, and x and y are integers.

In another aspect of the method, the additional polar fluid may be selected form the group consisting of ethanol, methanol, and mixtures thereof.

In another aspect of the method, the gel may be a silica-based or metal oxide-based gel.

In another aspect of the method, the pores may have a diameter in a range of 2-100 nm.

In another aspect of the method, generating the potential difference across the gel in the volume may include supplying a voltage across an anode and a cathode using a power supply.

In another aspect of the method, the method may comprise (e) contacting the gel with a supercritical fluid to create an aerogel.

In another aspect of the method, the supercritical fluid may be carbon dioxide (CO₂), ethanol, methanol, acetone, 2-propanol, xenon, hexane, or toluene.

In another aspect of the method, (e) may include positioning the volume into a pressure vessel.

In another aspect of the method, generating a potential difference across the gel in the volume may include supplying an anode and a cathode using a power supply, wherein the anode and the cathode are placed outside of the pressure vessel or within the pressure vessel.

In another aspect of the method, the volume may comprise a plurality of plates arranged from a proximal end to a distal end.

In another aspect of the method, (a) may comprise forming the gel in a gel mold.

These aspects are nonlimiting. Other aspects and features of the systems and methods described herein will be provided below.

### BRIEF DESCRIPTION OF THE DRAWINGS

FIG. 1 is a diagram of the electro-osmotic effect in a pore of an example silica aerogel, according to aspects of the present disclosure.

FIG. 2 is a schematic of an example electro-osmotic-assisted system, according to aspects of the current disclosure.

FIG. 3 is an exploded view of an example the electro-osmotic-assisted system of FIG. 2, according to aspects of the present disclosure.

FIG. 4 is a schematic of an example of the electro-osmotic-assisted system of FIG. 2, according to aspects of the present disclosure.

FIG. 5 is a flow chart of the electro-osmotic-assisted method for aging and/or drying a gel, according to aspects of the present disclosure.

FIG. 6 is a schematic of an example one-dimensional single pore domain in a gel, according to aspects of the present disclosure.

FIG. 7 is a plot of the concentration of contaminated ethanol in a single pore as shown in FIG. 4 over time, according to aspects of the present disclosure.

FIG. 8 is a plot of measured flow rate versus applied potential difference across an alcogel, according to aspects of the present disclosure.

FIG. 9 is a schematic of an example electro-osmotic system within a supercritical fluid pressure vessel, according to aspects of the present disclosure.

### DETAILED DESCRIPTION

The present disclosure provides systems and methods for accelerating the aging and/or drying process of making aerogels via the use of an external electric field to induce an electro-osmotic flow inside the pores of a gel having a polar fluid with pores of the gel, rather the relying solely on diffusion-limited mass exchange.

To overcome the time and cost of conventional aerogel manufacturing that requires long, involved, and costly processing, the present disclosure provides systems and methods that enable aging and/or drying of gels with polar fluids within pores of the gel, such as an alcogel, to transform them to aerogels in minutes rather than hours-to-days (depending on product thickness) and thus, reduce the currently expensive manufacturing cost of aerogels.

Aerogels are a class of synthetic, porous, ultralight material derived from a gel, in which the liquid component for the gel is replaced with a gas, without significant collapse of the pores and overall gel structure. Their precursors, alcogels, contain an alcohol, or more generally a polar fluid, within their pores after the solution-to-gel formation since alcohols such as methanol or ethanol are frequently used in making the gels.

Silica aerogels are the most common type of aerogel, but may also be made of, but are not limited to, carbon, metal oxide, agar, polyimide, cellulose, or chalcogens. For example, metal oxides may include alumina, titania, zirconia, iron oxide, chromia, vanadia, neodymium oxide, samaria, holmia, or erbia. In another example, chalcogens may include, but are not limited to, sulfur or selenium. In a preferred embodiment, the gel described herein is a silica-based or metal-oxide based gel.

After an alcogel is formed, but before drying, it undergoes a solvent exchange process, i.e., aging, to ensure that water and other contaminants are removed from the pores. This involves submerging the alcogel in an alcohol bath in which a two-way diffusion mass transfer occurs as the pore fluid slowly diffuses outward and the fresh alcohol slowly diffuses into the gel. This process takes hours to days and requires, periodically, discarding the contaminated alcohol surrounding the alcogel and replacing it with pure alcohol, which must be recycled. As will be described below, the electro-osmotic process herein reduces the volume of alcohol to be recycled as a much smaller volume of alcohol surrounds the gel and is never replenished.

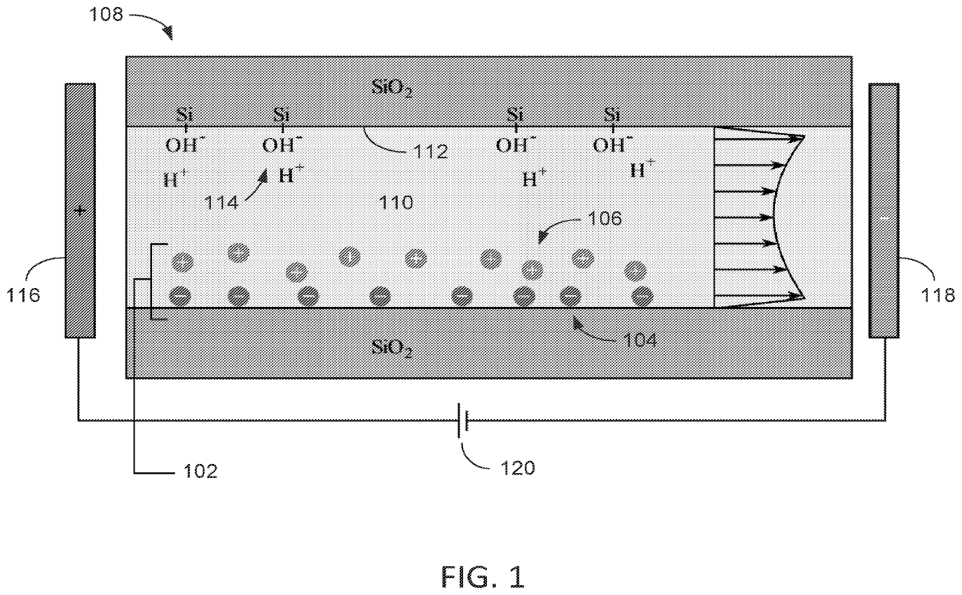

Referring to FIG. 1, the proposed technique exploits the electric double layer 102 of immobile negative ions 104 and mobile positive ions 106 naturally formed inside the pores 108 of a gel with a polar fluid 110 with the pores 108 at the wall surface 112 due to interfacial chemical reactions 114 (e.g., deprotonation of silanol groups) between silica and the polar fluid. When exposed to an external electric field generated between an anode 116 and cathode 118 from a power supply 120, the mobile ions move away from the surface, dragging the surrounding fluid and creating a velocity profile. FIG. 1 exhibits a water-silica system, whereby the OH ions 104 in the water 110 are pinned to the wall 112 of the pore 108 via interaction with the silica and the corresponding H⁺ ions 106 are mobile. The external potential difference 120 applied across the pore 108 induces a Coulomb force on the H⁺ ions 106. They drag along the neutral water molecules in the middle section of the pore 108, resulting in a flow with the highest velocity near the wall 112 and thus inducing a plug-like velocity profile as opposed to that of a pressure-driven flow, which is parabolic. This works especially well in (small diameter) capillary tubes as the force per unit volume of fluid is large.

In an aspect of the present disclosure, the pores have a diameter in a range of 2-100 nm, or 5-50 nm. to maximize the electro-osmotic effect. Smaller pore sizes, at or below 1 nm may reduce the electro osmotic flow rate to substantially zero. For example, in typical silica aerogel, the Debye length (electric double layer thickness) is about 2 nm and thus affecting the electro osmotic flow at pore sizes≤1 nm. At pores sizes up to 100 nm, the electro osmotic flow is effectively constant. Larger pore sizes are possible; however these gels fall outside the designation of an aerogel. In these large pore sized gels (>100 nm), pressure driven flow is a more effective means of driving flow.

According to the capillary model shown in FIG. 1, the volumetric flow rate, Q, across a porous medium is given an applied voltage as

$$Q = - \frac{εζψ VA}{τ μ L} ( 1 - \frac{2 λ {I}_{1} ( a / λ )}{{aI}_{0} ( a / λ )} ) \qquad ( 1 )$$

where ε is the porosity, ζ is the zeta potential of the wall, ψ is the dielectric constant of the fluid, V is the applied voltage, A is the cross sectional area, τ is the tortuosity of the porous medium, μ is the viscosity of the fluid, L is the length of the porous medium, α is the average pore radius, λ is the electric double later thickness, and Iₙ is the n^{th}-order modified Bessel function of the first kind. In the limiting case of electric double layer overlap where the capillary diameter is on a similar scale with lambda as is the case with the smallest pore size distribution of silica aerogel, typically mesopores (2-50 nm) range, the induced flow rate decreases as the pore is smaller than 10 nm.

In accordance with a non-limiting example of the present disclosure, a system for aging and/or drying an alcogel is described. The system comprises a gel having a polar fluid within pores of the gel, wherein an electrical double layer is formed on at least a portion of inner surfaces of the pores of the gel, an anode, a cathode, wherein the cathode is spaced apart from the anode to define a volume for receiving the gel, a power supply in electrical communication with the anode and the cathode for generating an electro-osmotic flow of the polar fluid toward one of the anode or the cathode, and a source containing an additional fluid, wherein the source is configured to supply the additional fluid to the pores of the gel.

In a non-limiting example, the power supply may be a DC power supply. In a further example, the power supply is electrically coupled to the volume via wired connection. In a non-limiting example, a first wire connects an anode on one side of the volume to a positive voltage (V+) port in the power supply and a second wire connects a cathode on the opposite side of the volume to the anode to a negative voltage (V−) port in the power supply, creating an external electric field surrounding the alcogel. In a non-limiting example, more than one anode and cathode may be utilized in the system.

In a non-limiting example, the source containing an additional fluid may be a fluid tank or fume hood fitting with a conduit connecting it to the volume. Alternatively, the source may be a container filled with the additional fluid configured to submerge the volume. In the case where the source of the additional fluid is a container, the anode and cathode may be submerged within the container, or alternatively are posited outside of the container. In the latter embodiment, the power supply may be adjusted to ensure an electric field is still generated across the volume containing the gel.

The electro-osmotic chamber can comprise a plurality of plates stacked from a proximal to a distal end. In a non-limiting example, the plates are acrylate plates. In a further example, a first mesh electrode is positioned near the proximal end within the electro-osmotic chamber, and a second electrode is positioned near the distal end within the electro-osmotic chamber. In a further example, the first (positive) and second (negative) wire from the power supply connect to the first (positive) mesh electrode and second (negative) mesh electrode, respectively.

In a non-limiting example, the additional fluid is a different polar fluid than the polar fluid. For example, gelation may have taken place in a methanol solution, whereupon the additional fluid would be a different polar fluid that is not methanol, for example, ethanol. Alternatively, the polar fluid and additional fluid may be any alcohol having the chemical formula RₓCH_{y}OH, where x=3−y, and where x and y are integers. In a non-limiting embodiment, the polar fluid and additional fluid may be any C₁-C₈ alkanol. Alternatively, the additional fluid may be carbon dioxide (CO₂), methanol, ethanol, acetone, 2-propanol, xenon, hexane, toluene, or other suitable fluid for supercritical drying of the gel.

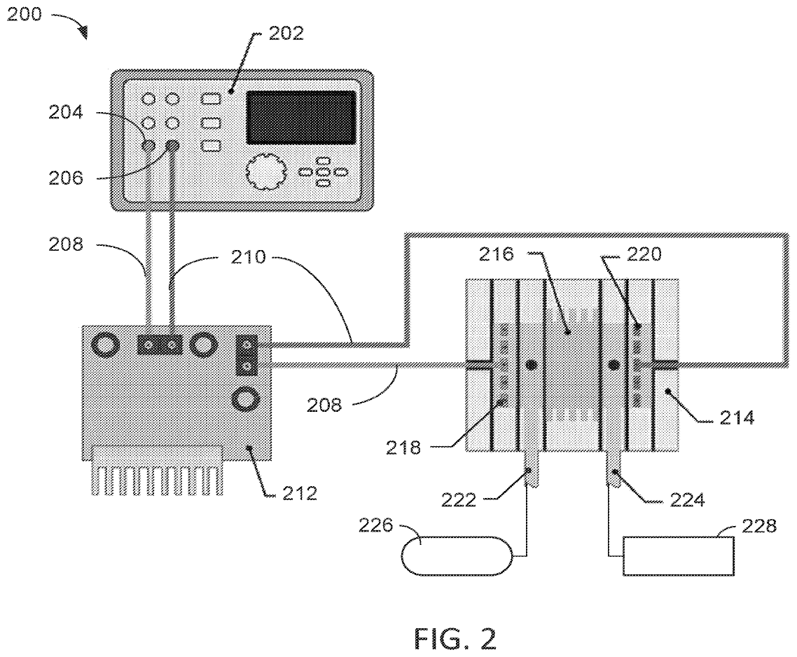

Referring to FIG. 2, a non-limiting example system 200 for aging and/or drying aerogels is shown. In this embodiment, the volume for receiving the gel includes an electro-osmotic chamber 214 which provides a structure to contain the various elements of the electro-osmotic system as will be described herein. The terms “volume” and “electro-osomotic chamber” for containing the gel may be used interchangeably herein. A power supply 202 includes V+ 204 and V− 206 ports, within which a first wire 208 and second wire 210 are inserted, respectively. The wires may connect to an optional amplifier 212 or directly to an electro-osmotic chamber 214 containing a gel 216. The gel 216 in this example may be an alcogel. Specifically, the first wire 208 is electrically connected to the anode 218 and the second wire 210 is electrically connected to a cathode 220. In this example, the anode is a first mesh electrode 218 the cathode is a second mesh electrode 220. In one aspect, the first and second mesh electrodes 218 and 220 have higher permeability than the gel, and thus reduce the resistance of the flow of the polar fluid and additional fluid. However, one of ordinary skill in the art will recognize that the mesh electrode representing the anode and cathode will depend on their connections to V+ 204 and V− 206, respectively.

The electro-osmotic chamber 214 further includes a first tube 222 and a second tube 224. In a non-limiting example, the first tube 222 is connected to a source of an additional fluid 226 to introduce the additional fluid into the electro-osmotic chamber 214. As previously stated, the source 226 may be, but is not limited to a fluid tank, fume hood attachment, or container. Further, the second tube 224 is connected to a collection container 228 to receive the polar fluid out of the electro-osmotic chamber from the second tube 224. As will be understood by one of ordinary skill in the art, based on the connection of the first mesh electrode 218 and second mesh electrode 220 with the power supply 202, the additional fluid supply 226 and collection container 228 may be switched to connect to the second tube 224 and first tube 222, respectively, resulting in a reverse fluid flow inside the electro-osmotic chamber 214.

In a non-limiting example, the first wire 208 and second wire 210 are enamel coated wires in order to isolate the applied voltage from the working fluid inside the electro-osmotic chamber.

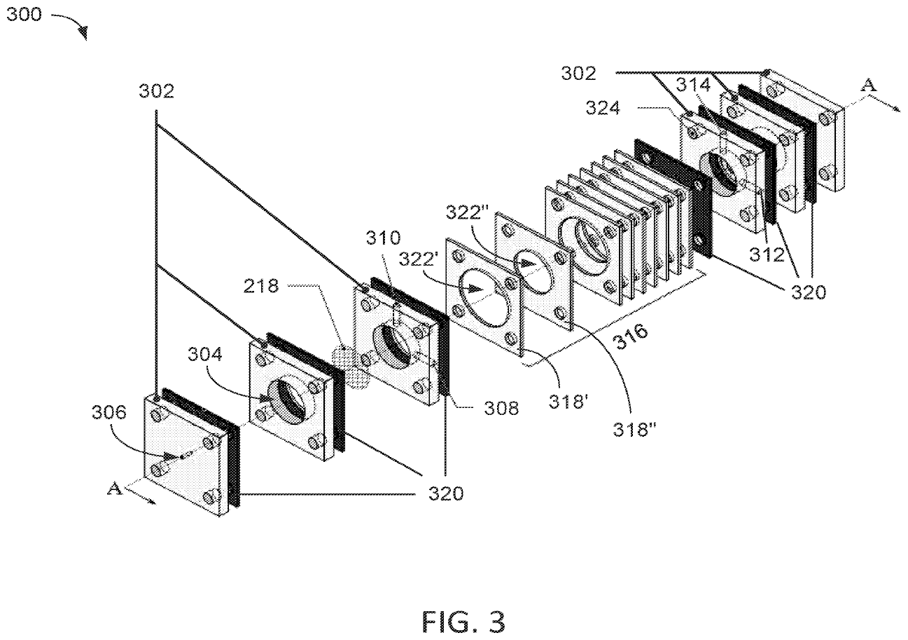

Referring now to FIG. 3, a non-limiting example of the electro-osmotic chamber 300 is shown in an exploded schematic. The electro-osmotic chamber may be the same electro-osmotic chamber 200 of FIG. 2. In a non-limiting example, the electro-osmotic chamber comprises a plurality of plates 302 arranged in parallel from a proximal end to a distal end. In a non-limiting example, the plates may be fabricated from any electrically insulated material. In one non-limiting example, the plurality of plates are acrylic plates.

Each plate 302 includes an opening 304. In a non-limiting example, each opening 304 is circular. Alternatively, each opening 304 is not limited to a circular shape and may be square, rectangular, triangular, irregular, or any other desired shape. In a non-limiting example, the outermost plates at the proximal and distal ends of the electro-osmotic chamber 300 include openings configured to introduce the first wire 208 and second wire 210, respectively.

The plates adjacent to the outermost plates include openings configured to hold the first mesh electrode 218 and second mesh electrode 220. The first wire 208 and second wire 210 contact the first mesh electrode 218 and second mesh electrode 220, respectively, and thereby electrically connect to the power supply 202.

The next inward plates adjacent to the mesh electrode-containing plates include first and second horizontal ports 308 and 312, which are configured to fit the first tube 222 and second 224 of FIG. 2, respectively. The first and second horizontal ports 308 and 312 traverse a first axis of the planar surface of the plate 302 parallel with a bottom surface of the plates until they reach the opening 304. Additionally, these plates include first and second vertical vents 310 and 314, which are configured to equilibrate the electro-osmotic chamber 300 by releasing residual gas. The first and second vertical vents 310 and 314 traverse a second axis of the planar surface of the plate 302 that is perpendicular to the first axis and open to the top surface of the plates. Further, the first and second vertical vents 310 and 314 are configured to fit a first plug and second plug, respectively (not shown in FIG. 3). In this configuration, the electro-osmotic chamber 300 is arranged such that the first vertical vent 310 and second vertical vent 314 are in parallel with the direction of gravity, and the first horizontal port 308 and the second horizontal port 312 are arranged perpendicular to gravity.

The plurality of plates 302 are mirrored around a gel mold 316 comprising a plurality of stacked plates 318′, 318″. In a non-limiting example, a plurality of gaskets 320 are sandwiched between adjacent plates, and between the port and vent-containing plates and the gel mold 316. The plurality of gaskets prevents leakage of the electro-osmotic chamber 300. The plurality of gaskets 320 also includes openings matching those of the adjacent plates 302. At ambient condition, such as in the aging process, the gasket materials may be, but are not limited to Viton® fluorine rubber, Kalrez® perfluoroelastomer, PTFE, rubber, or silicone based on its compatibility with the working fluid. In a non-limiting example, the plurality of gaskets 320 are Buna-N gaskets. In a non-limiting example, Buna-N gaskets are preferred for the drying processes in super critical fluid conditions, as this material tends to resist swelling.

In a non-limiting example, the gel mold 316 comprises a plurality of stacked plates 318′, 318″. For example, these plates may be identical in material and dimension to the plurality of plate 302. Further, each stacked plate 318′, 318″ includes openings 322′ and 322″. In one example, openings 322′ and 322″ are circular. Alternatively, each opening 322′, 322″ is not limited to a circular shape and may be any shape. In one example, openings 322′ and 322″ are the same size. In another example, openings 322′ and 322″ are different sizes. In a non-limiting configuration of the gel mold 316, adjacent stacked plates alternate between stacked plates 318′ with opening 322′ of a specific size and stacked plates 318″ with openings 322″, wherein 322′ and 322″ are different sizes. Alternatively, each opening in the stacked plates of the gel mold 316 may be a different size from every other opening. In a non-limiting example, nine 1/16″ thick acrylic stacked plates of the gel mold are arranged with alternating opening of 1″ and 1.3″ diameter. In a non-limiting example, an alcogel 216 is formed inside the gel mold 316. Prior to gelation, a “gel” is in a liquid form called a solution. Once a catalyst is added, the gel solution can be poured into a mold before solidification, such as a time period of about 1-2 min. In this example of adjacent stacked plates 318′, 318″ with opening 322′, 322″, the solution will solidify into a tubular shape with alternating diameters along the length of the gel. The alternating diameters provide a means for the gel to seal itself against the adjacent stacked plated of the gel mold 316.

In the example of FIG. 3 with the alternating openings in the stacked plates of the gel mold 316, the molded alcogel takes the shape of an alternating stepped cylinder, creating a series of lips on the gel between the plates and thus, a hermetic seal. Alternatively, the gel may be poured into any desired shape, depending on the desired final application of the resulting aerogel.

In a non-limiting example wherein a gel 216 is formed inside the gel mold 316, the gel mold 316 is assembled along with the plurality of plates as previously described to form the electro-osmotic chamber 300. The plates and gel mold may be assembled using one or more mounting holes 324 in each plate 302 and stacked plate 322′, 322″ that align such that mounting screws (not shown) tighten and seal the electro-osmotic chamber.

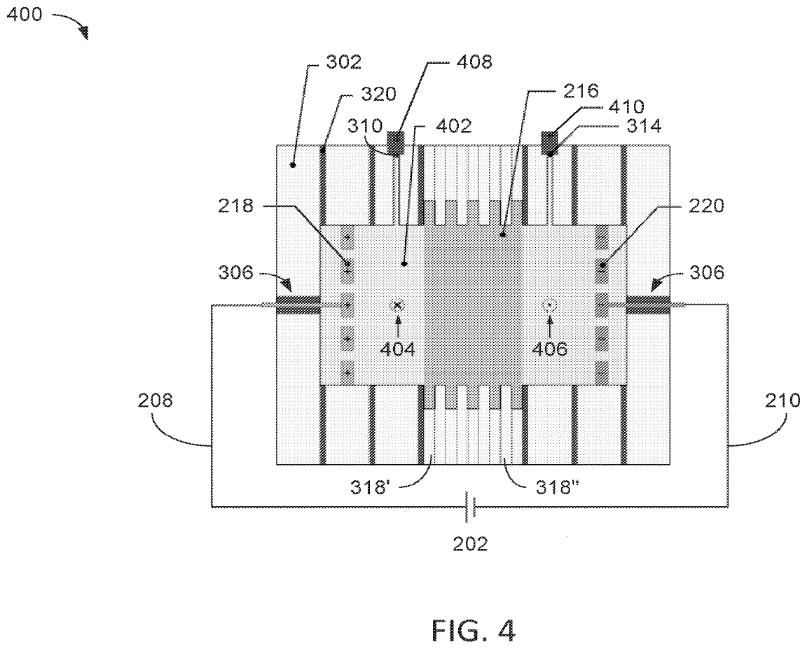

Referring to FIG. 4, a section view of an assembled electro-osmotic chamber 400 along the cutting plane A-A from FIG. 3 is shown. In a non-limiting example, the electro-osmotic chamber 400 shows the gel 216 within the electro-osmotic chamber 400 and surrounded by an additional fluid 402. In a non-limiting example, the additional fluid 402 may be a polar fluid, an alcohol, an alkanol (e.g., any C₁-C₈ alkanol), CO₂, or any suitable fluid as previously described supplied via a source, such as the source 226 of FIG. 2.

In a non-limiting example, the additional fluid 402 is introduced into the electro-osmotic chamber 400 via the fluid inflow 404 using a first syringe (not shown) or a first tube 222 as shown in FIG. 2 The additional fluid 402 flows through the electro-osmotic chamber and across the gel 216 and out of the fluid outflow 406 via a second tube 224 as shown in FIG. 2. In a non-limiting example, once the electro-osmotic chamber 400 is filled with the additional fluid 402, a first plug 408 is used to stop the first vent 310, and a second plug 410 is used to stop the second vent 314.

In a non-limiting example, a gel 216 was formed inside the gel mold 316 and assembled in the center of the electro-osmotic chamber 300, 400. A first mesh electrode 218 and second mesh electrode 220 connected to the external power supply 202 via first wire 208 and second wire 210, respectively, sandwiched the gel to apply a potential difference driving the fluid flow from the inlet port 404 to the outlet port 406 through the gel 216. Further in this example, the electro-osmotic chamber 400 was assembled by tightening 4 screws (not shown) through the mounting holes 324 with a buna-N gasket 320 between every two plates 302. Ethanol was charged inside the electro-osmotic chamber 400 using two syringes connected to the first and second horizontal ports 308 and 312 until it reached the top surface of the first and second vertical vents 310 and 314. Then, buna-N plugs 408 and 410 were used to seal the first and second vertical vents 310 and 314, respectively, creating an airtight test section completely filled with an additional fluid. The syringes were subsequently removed and replaced by a first tube 222 and second tube 224 with two ends elevated higher than the first and second vertical vents 310 and 314. The system was allowed to reach equilibrium, i.e., no movement within the tubes. Finally, the first mesh electrode 218 and the second mesh electrode 220 were connected to the high-voltage amplifier 212 and an electro-osmotic flow was generated.

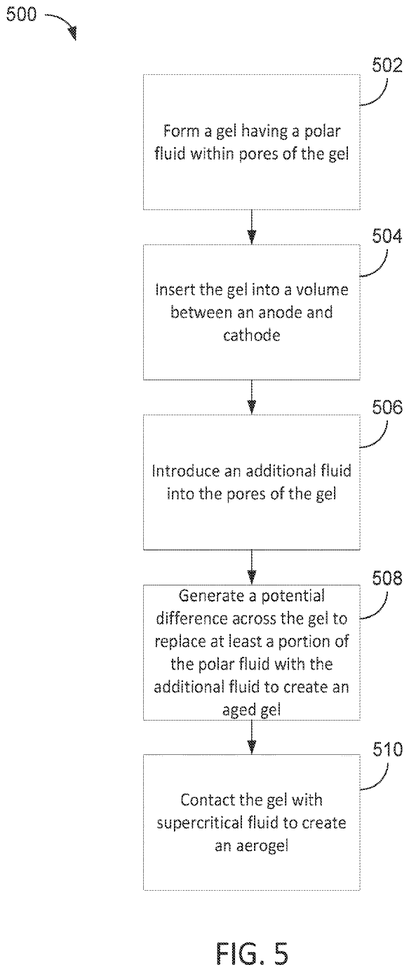

The following description provides a method of aging and/or drying a gel 500 in FIG. 5. At step 502, a gel having a polar fluid within pores of the gel is formed. In a non-limiting example, the gel is formed within a gel mold such as the gel mold 316 described previously. In a non-limiting example, the polar fluid may be an alcohol or alkanol, such as a C₁-C₈ alkanol (e.g., methanol, ethanol, or a mixture thereof), wherein the polar fluid at least partially fills the pores of the gel. In this non-limiting example, the gel is an alcogel. Next, at step 504, the gel or alcogel is inserted into a volume between an anode and a cathode. In a non-limiting example, the gel is placed within a gel mold of an electro-osmotic chamber as previously described in FIGS. 3 and 4.

At steps 506 and 508, an additional fluid is introduced into the pores of the gel and a potential difference is generated across the gel to replace at least a portion of the solvent with the fluid to create an aged gel. In a non-limiting example, steps 506 and 508 may proceed simultaneously.

In a non-limiting example, at step 506, introducing the fluid into the pores of the gel includes using two syringes each connected to a first port and a second port of the electro-osmotic chamber until a fluid level fills a first vent and a second vent of the electro-osmotic chamber, as previously described. Thereafter, the first vent is sealed with a first plug and the second vent is sealed with a second plug. Further, the two syringes are replaced with a first tube and a second tube.

In a non-limiting example, the first tube is coupled to a fluid supply to provide fluid flow into the electro-osmotic, and the second tube is coupled to a collection container to provide fluid flow out of the electro-osmotic chamber.

In a non-limiting example, at step 508, generating the potential difference across the gel includes supplying a voltage across the anode and the cathode using a power supply.

In a non-limiting example, optional step 510 is performed for drying the gel to produce an aerogel. The aged gel or alcogel is contacted with a supercritical fluid, such as SCCO₂, to obtain an aerogel. As previously stated, the supercritical fluid may alternatively be ethanol, methanol, acetone, 2-propanol, xenon, hexane, or toluene.

In one aspect, contacting the gel with a supercritical fluid includes positioning the volume containing the gel into a pressure vessel configured to with stand high pressures. Further, an additional fluid such as CO₂, methanol, ethanol, acetone, 2-propanol, xenon, hexane, or toluene is introduced into the pressure vessel and the pores of the gel, generating a potential difference across the alcogel in the electro-osmotic chamber to replace the fluid with within the pores with the additional fluid, such as CO₂. Further, the temperature of the additional fluid within the pressure vessel is increased to move the additional fluid into a supercritical fluid state. After a period of soaking the gel in the supercritical fluid and the electric field, the pressure is slowly reduced and the contaminated supercritical fluid is removed, whereupon the above steps are repeated until no alcohol is left in the gel. This process is known as batch drying. Alternatively, a continuous drying method may be used, wherein the additional fluid is heated upstream before introduction to the pressure vessel and is then introduced to the pressure vessel which is also heated. A continuous flow of supercritical fluid then slowly removes the alcohol from the gel. In the batch and continuous drying examples, the additional fluid is introduced in a liquid state and removed in a gaseous state.

The following examples provide further details of the systems and methods for aging and drying alcogels.

### Examples

The following Examples are provided to demonstrate and further illustrate certain embodiments and aspects of the present invention and are not to be construed as limiting the scope of the invention. The statements provided in the Examples are presented without being bound by theory.

The electro-osmotic system was tested to generate electroosmosis flow across an alcogel in deionized (DI) water. The pore size was approximately 2-50 nanometers, and the applied voltage was up to 400 VDC. We observed that instead of generating an electroosmosis flow, the provided power was consumed to split water into hydrogen and oxygen gas via electrolysis. This was due to a current connecting the electrodes in place of an electric field. Despite water, ethanol, and silica being non-conductive, the pore fluid inside the alcogel was conductive due to salt forming during the sol-gel process. With 90-99% porosity, the gel then bridged the electrodes, completing the circuit for current to flow through the test section. To avoid this issue, enamel coated wire was used to isolate the applied voltage from the working fluid. Water was replaced with ethanol as the working fluid to replicate the ageing environment.

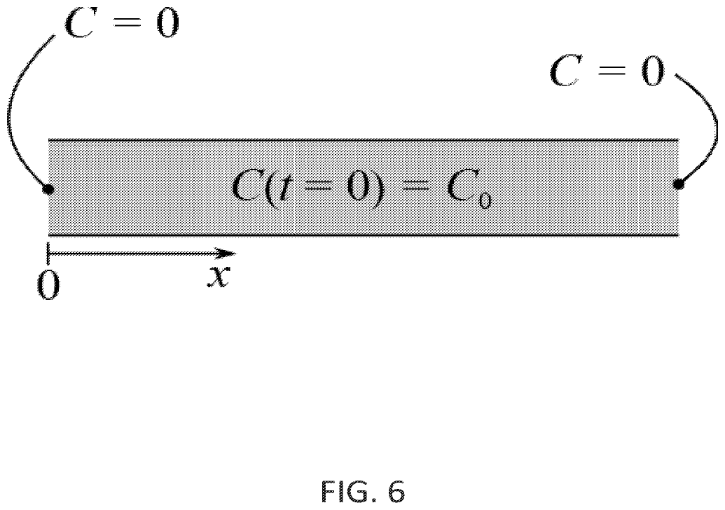

FIG. 6 shows a schematic of a simplified 1D domain for a single pore initially filled with contaminated ethanol. The relevant diffusion equation is

$$\frac{\partial C}{\partial t} = D \frac{{\partial }^{2} C}{\partial {x}^{2}} \qquad ( 2 )$$

where C is the concentration of contaminated ethanol and D=1×10⁻⁹ m²/s is the diffusion coefficient of ethanol.

The initial condition is

$$C ( t = 0 ) = {C}_{0} \qquad ( 3 )$$

where C₀ is the initial concentration of contaminated ethanol.

The boundary conditions are

$$C ( x = 0 ) = C ( x = L ) = 0 \qquad ( 4 )$$

where L is the thickness of the gel ( 9/16 in), assuming that the pore spans the entire gel thickness. Using the method of separation of variables, we obtain the solution as

$$C = \frac{4 {C}_{0}}{π} {\sum }_{n = 0}^{∞} \frac{1}{2 n + 1} sin \frac{( 2 n + 1 ) π x}{L} exp ( - D \frac{{( 2 n + 1 )}^{2} {π}^{2} {t}^{2}}{{L}^{2}} ) \qquad ( 5 )$$

This result is conservative in the sense that it does not account for the buildup of ethanol in the solution surrounding the gel.

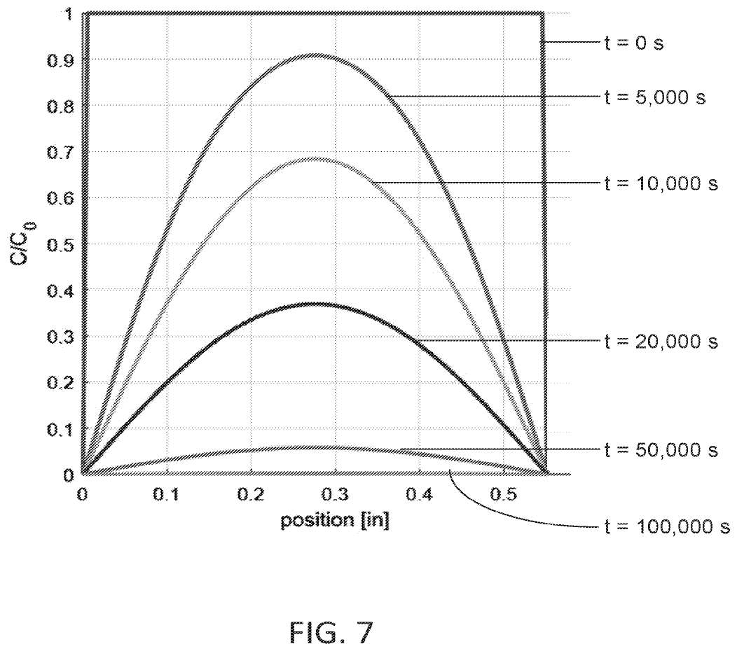

The corresponding analytical results are shown in FIG. 7. The plot in FIG. 7 indicates that it would take approximately 22 hours to remove 99% of the contamination from the middle of the gel assuming pure diffusion. This estimate is on a similar scale compared to conventional ageing and solvent exchange done in the literature (J. Griffin, D. Mills, M. Cleary, R. Nelson, V. Manno, and M. Hodes. Continuous extraction rate measurements during supercritical CO₂ drying of silica alcogel. J. of Supercritical Fluids, 94:38-47, (2014)).

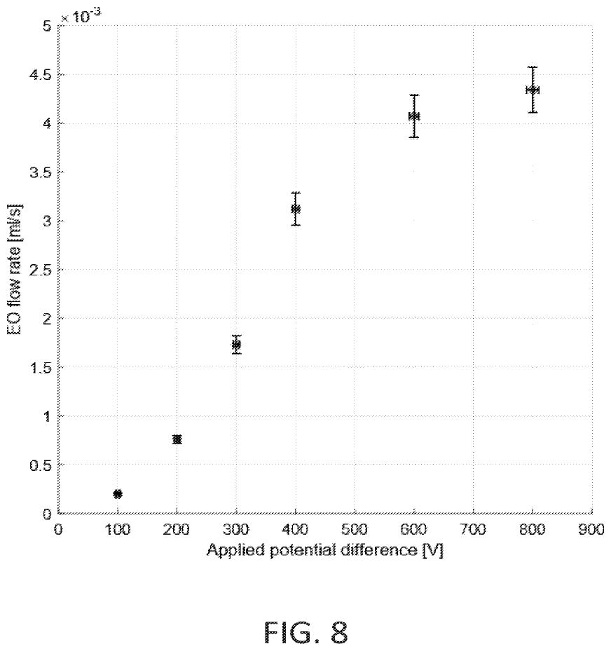

Electro-osmotic flow was successfully generated across an 9/16″ thick×1″ (effective) diameter alcogel puck at varying externally applied potential difference from 100-800 VDC as shown in FIG. 8. Fresh ethanol can be pumped across the gel, replacing contaminated pore fluid, in approximately 30 minutes at the highest applied voltage, significantly faster compared to conventional time scale for diffusion-limited solvent exchange. The significant improvement in mass transport enables roll-to-roll solvent exchange as the wet-gel continuously moves through a fresh alcohol bath.

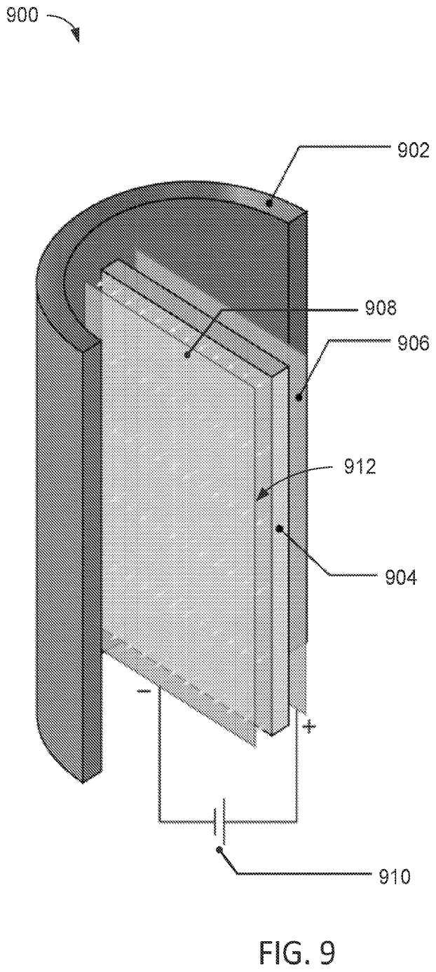

Referring now to FIG. 9, a schematic incorporating electro-osmotic flow in a conventional supercritical fluid drying apparatus 900 is shown, wherein inside a pressure vessel 902 a monolith alcogel 904 is sandwiched between an anode 906 and a cathode 908 powered by a power supply 910 to induce a flow 912 inside the pores of the alcogel. In a non-limiting example, the anode 906 and cathode 908 may be mesh electrodes as previously described. This non-limiting example design allows for the full advantages of supercritical fluid drying, and at the same time, significantly reduces resources such as the amount of additional fluid and energy required to completely extract the pore polar fluid. The mesh electrodes (with permeability significantly higher than that of the gel) allow solvent to flow through without introducing a significant flow resistance.

It an alternative embodiment, the anode 906 and cathode 908 may be positioned outside of the pressure vessel 902 and on opposite sides of the pressure vessel 902.

The present invention has been described in terms of example embodiments, and it should be appreciated that many equivalents, alternatives, variations, additions, and modifications, aside from those expressly stated, and apart from combining the different features of the foregoing versions in varying ways, can be made and are within the scope of the invention. While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosures described herein can be embodied within a form that does not provide all of the features and benefits set forth herein, as some features can be used or practiced separately from others. The scope of certain disclosures disclosed herein is indicated by the appended claims rather than by the foregoing description. All changes which come within the meaning and range of equivalency of the claims are to be embraced within their scope.

1. A system for aging and/or drying a gel having a polar fluid within pores of the gel, the system comprising:
a gel having a polar fluid within pores of the gel, wherein an electrical double layer is formed on at least a portion of inner surfaces of the pores of the gel;
an anode;
a cathode, wherein the cathode is spaced apart from the anode to define a volume for receiving the gel;
a power supply in electrical communication with the anode and the cathode for generating an electro-osmotic flow of the polar fluid toward one of the anode or the cathode; and
a source containing an additional fluid, wherein the source is configured to supply the additional fluid to the pores of the gel.

2. The system of claim 1, wherein the volume includes a series of plates arranged from a proximal end to a distal end of the volume.

3. The system of claim 2, wherein the series of plates includes (i) a plate, at the proximal end, including a first opening adjacent to (ii) a plate including a hole with the anode therein adjacent to (iii) a plate including a first vertical vent and first horizontal port adjacent to (iv) a gel mold adjacent to (v) a plate including a second vertical vent and a second horizontal port adjacent to (vi) a plate including a hole with the cathode therein adjacent to (vii) a plate, at the distal end, including a second opening.

4. The system of claim 3, wherein the first opening is configured to allow an electrical connection from the power supply to the anode, and the second opening is configured to allow an electrical connection from the power supply to the cathode.

5. (canceled)

6. The system of claim 3, wherein the first horizontal port and the second horizontal port are configured to receive a first tube and second tube, respectively.

7. The system of claim 6, wherein the first tube is coupled to the source containing the additional fluid to introduce the additional fluid into the volume, and the second tube is coupled to a collection container to receive the polar fluid out of the volume.

8. The system of claim 3, wherein the first vertical vent and the second vertical vent are configured to receive a first and second plug, respectively, to seal the volume.

9. The system of claim 3, wherein the gel mold comprises a plurality of stacked plates, each stacked plate including an opening.

10-11. (canceled)

12. The system of claim 9, wherein each adjacent plate in the plurality of stacked plates includes alternating openings of a first size and a second size, wherein the first size and the second size are different.

13. The system of claim 3, wherein a gasket is positioned between each adjacent plate and between the gel model and each adjacent plate, to seal the volume.

14. The system of claim 3, wherein the gel is positioned within the gel mold.

15. (canceled)

16. The system of claim 1, wherein the additional fluid is a different polar fluid than the polar fluid.

17. The system of claim 16, wherein the additional fluid is an alcohol having the formula RₓCH_{y}OH, wherein x=3−y, and x and y are integers.

18. The system of any one of claim 16, wherein the additional polar fluid is selected from the group consisting of ethanol, methanol, and mixtures thereof.

19. The system of claim 1, wherein the additional fluid includes carbon dioxide (CO₂), ethanol, methanol, acetone, 2-propanol, xenon, hexane, or toluene.

20. The system of claim 1, wherein the gel is an alcogel, a silica-based gel, or a metal oxide-based gel.

21. (canceled)

22. The system of claim 1, wherein the pores have a diameter in a range of 2-100 nm.

23. A method of aging and/or drying a gel having a polar fluid within pores of the gel, the method comprising:
(a) forming a gel having a polar fluid within pores of the gel, wherein an electrical double layer is formed on at least a portion of inner surfaces of the pores of the gel;
(b) inserting the gel into a volume between an anode and a cathode;
(c) introducing an additional fluid into the pores of the gel; and
(d) generating a potential difference across the gel to replace at least a portion of the polar fluid with the additional fluid to create an aged gel.

24. (canceled)

25. The method of claim 23, wherein the gel is an alcogel.

26-35. (canceled)

36. The method of claim 23, further comprising (e) creating an aerogel by diffusion or by contacting the gel with a supercritical fluid and generating a potential difference across the gel.

37-41. (canceled)
